(19) United States
(12) Patent Application Publication
(10) Pub. No.: US 2013/0133172 A1
(43) Pub. Date: May 30, 2013

(54) METHOD FOR THE AUTOMATED MOUNTING OF MODULES ON RECEIVING DEVICES, IN PARTICULAR SOLAR MODULES ON STANDS AND MOBILE MOUNTING DEVICE FOR SUCH MODULES

(71) Applicants: Waldemar Kiener, Lauchheim (DE); Bernd Brodbeck, Nurtingen (DE)

(72) Inventors: Waldemar Kiener, Lauchheim (DE); Bernd Brodbeck, Nurtingen (DE)

(21) Appl. No.: 13/701,576

(22) PCT Filed: Jun. 3, 2011
(86) PCT No.: PCT/EP2011/059192

§ 371 Date: Feb. 11, 2013

(30) Foreign Application Priority Data
Jun. 2, 2010 (DE) 1020100225711

(51) Int. Cl. B60P 1/00

(52) U.S. Cl. CPC B60P 1/00
USPC 29/428; 414/539

(57) ABSTRACT

The invention relates to a method and to a mobile mounting device (11) for the automated mounting of modules (16) on receiving devices (17), in particular of solar modules on stands, in which method a module (16) is gripped by a mounting tool (24), wherein, before transferring the module (16) to the mounting position (36), the handling device (21) is transferred to a measuring position (35) above the mounting position (36), the location of mounting points (37) in the mounting position (36) is determined, the module (16) is transferred to the mounting position (36) starting from the measuring position (35), and the assembly movement is carried out automatically.

The invention relates to a method for the automated mounting of modules on receiving devices, in particular solar modules on stands and a mobile mounting device for mounting the modules on the stands.

To generate energy, more and more solar plants are being built as free-standing solar plants. Such solar plants and solar parks extend over several thousand square metres. Individual solar modules are connected to receiving devices, in particular stands, which are in turn fixed tightly to the ground. In such free-standing solar plants, the solar modules are connected tightly to the stand, wherein the stands extend over several metres in a longitudinal direction and, in most cases, rows of such stands are arranged at a distance to one another and are aligned mostly in parallel. The individual solar modules are alongside each other and, depending on their screening, are mounted on the receiving device and, for example, arranged in one, two or three rows on top of each other. The stand can also follow the sun and be moved by two axles which are referred to as so-called “movers”.

Such solar modules, which have, for example, a format of 2 m×2.60 m in a large embodiment, and a weight of up to, for example, 150 kg, are presently fitted and mounted to the stand manually. This is heavy physical labour. Manual mounting is also time-consuming. Also, the danger of damaging such solar modules is increased by manual mounting, so that up to an additional 10% of the solar modules to be installed are required due to damages. There is a considerable accident risk during manual mounting.

To assist so-called mounting of large-scale solar modules, a manually controllable mounting machine is known from the company Maschinenbau Riebsamen GmbH & Co. KG, which is available under the reference RPS 007/Riebsamen Panel System. This mounting machine comprises a mobile mounting device with a chassis. A handling device with a gripper is provided on this chassis. To control the removal of a solar module using this gripper and the subsequent positioning on the stand, a remote control unit is used, with which the operator, for each, specifically controls the individual movements of the removal of the solar module from the repository up to the fitting and mounting of it on the stand. Such a mobile mounting device is indeed advantageous in that the large-scale modules are transferred from the repository to the stand by a tool; however, the operating cycle is to be controlled individually by the operator for each solar module and requires considerable practical experience to fit the solar modules to the stand in a time-saving manner.

The object of the invention is therefore to propose a method for the automated mounting of such modules, their allocation on the mounting area and a mounting device for carrying out said mounting, which shortens and simplifies the mounting time.

This object is solved according to the invention by a method according to the features of claim 1 and by a mobile mounting device according to the features of claim 10. Further advantageous embodiments are provided in the respective independent claims.

Provision is made in this method for a mobile mounting device having a handling device and a mounting tool which can be applied thereto, together with at least one repository having modules mounted thereon, to be moved into a handling position with respect to a receiving device. Then the module is gripped by the mounting tool, the module is removed from the repository and, before transferring the module to a mounting position to fix the handling device onto the receiving device, the handling device is transferred to a measuring position above the mounting position, so as to determine the location of mounting points in the mounting position and, from this, to transfer the module to the mounting position. Thus a mounting cycle can be activated once and then carried out automatically. In this design, there is the advantage that the positioning of the mobile mounting device can be located in rough proximity to the mounting position. Due to the exact determination of the mounting position from the measuring position, it is not necessary for the positioning of the mobile mounting device to the mounting position to be exact.

A fast and precise mounting of the solar modules onto the stands or of glass-façade modules onto buildings can be enabled by the method for mounting modules onto receiving devices according to the invention, wherein the danger of breaking the modules is considerably reduced. By shortening the mounting time, in particular in large free-standing solar plants, solar plants can be completed in a shorter period of time and thus generate energy at an earlier point in time. This leads to a considerable optimisation of costs. In additional, moving the mobile mounting device to the next mounting position, as well as handling the module for transfer from the repository to the mounting position, can, for example, be enabled with only one person. This also leads to savings in staff, a reduction in the risk of accidents and to the activity being facilitated.

An advantageous design of the method provides for the handling device to have at least one measuring device, preferably cameras arranged at distance from one another, with which the mounting points are detected for the module from a measuring position and the mounting position is determined. This procedure has the advantage that, by attaching the measuring device to the mounting tool, based on the measuring position after the mounting points have been determined, only one input movement of the module into the mounting position is required. At the same time, a direct link to the handling device between the assumed measuring position is thus detected and calculated in proportion to the mounting position, so that the input of the handling device into the mounting position is carried out at a high level of accuracy and is not dependent on the positioning of the mobile mounting device as to the receiving device being exact.

A preferred design of the method provides for a handling position to be assigned to one or more mounting positions when there are several mounting positions arranged in a row on the receiving device, and for the handling position to be determined by a positional movement of the mobile mounting device, in particular a navigation system or differential navigation system. Thus a predetermined movement that has been controlled by a navigation system between the individual handling positions and thereby the mounting positions can be enabled.

In particular, by applying a differential GPS, an exact positioning of the vehicle in the mounting position as to the receiving device, and in particular with respect to their alignment to the longitudinal axes, can be detected and determined, so that, on this basis, and taking into consideration the exact position of the vehicle, the mounting position of the module can be determined.

A further preferred design of the method provides for there being a measuring mark provided for each handling position for module-mounting when there are several mounting positions arranged in a row on the receiving device, which is detected by a detection device of the mobile mounting device, and for the mobile mounting device to be controlled by the detection device and moved into the handling position. The measuring mark for the handling position can be provided in such a way that, in this handling position of the vehicle, one or more mounting positions can be carried out to arrange the modules on the receiving device. This embodiment enables the mobile mounting device to be positioned directly on measuring marks or defined features of the receiving device, and for it to be moved selectively from the one handling position to the next handling position.

A further preferred design of the method provides for there to be a tool exchange after each module has been positioned in the mounting position on the receiving device, and for the handling device to fix the module using a mounting tool, in particular a power screwdriver. Thus the mounting can be entirely automated. It is possible for the screws and other fixing elements to be potentially required to be input automatically.

Provision is preferably made for the modules, in particular without tools or tool exchanges, to be mounted on the receiving device fully automatically by an assembly transfer. Such an assembly transfer can comprise, for example, assembly processes such as insertion, clipping, locking or suchlike, which can be carried out automatically in a simple manner while the module is being fitted to the receiving device. Thus, a further automatic alignment and automatic centering of the modules as to the receiving device can also additionally be carried out, so that these modules are mounted exactly alongside each other in an end location.

A further preferred design of the method provides for at least two repository spaces each having one repository to be assembled on the mobile mounting device, and for the handling device to remove the modules from a first repository, then remove the modules from the second repository after emptying the first repository, and for the first emptied module to be exchanged with a full module. Thus a high processing speed can be achieved. The working time for carrying out the individual mounting cycles and for allocating the number of modules in a repository enables there being an adequate amount of time remaining to resupply a new repository, until a full repository is processed. Thus the overall mounting time can be reduced.

Furthermore, provision is preferably made for the mounting cycle to be initiated by a control signal after positioning the mobile mounting device in a handling position, and for the individual working steps from the removal of the module from the repository to its mounting on the receiving device and a return to a starting position, or for a computerised control of a further removal position for a subsequent repository, to be monitored and carried out. This mounting cycle is initiated by a starting command by operating personnel or an operator of the mobile mounting application. Subsequently, this mounting cycle sequence is carried out fully automatically without any further active support from an operator being required.

A further preferred design of the method provides for the repository attached to the vehicle to be transferred from a transport position to a removal position before each module is removed for transfer to a mounting position, and in particular for the repository to be positioned with a longitudinal carriage at a distance from the handling device, thereby creating a removal space between the handling device and the repository. This design enables the vehicle to be able to be constructed compactly in terms of its dimensions during the movement. The repository preferably has an extractable drawer, from which the modules can be removed in isolation. Receiving the modules with conveyance aids, such as palettes, is possible both horizontally and vertically, wherein these conveyance aids are positioned on the vehicle.

The object is additionally solved by a mobile mounting device, in particular for carrying out the method, which consists of a vehicle and at least one repository arranged thereon, in which several modules are stored, wherein at least one uniaxial handling device having a mounting tool which can be applied thereon is provided on the vehicle, with which the modules can be removed from the repository, and having a control device with which the handling device can be activated, wherein a measuring device is provided on the handling device, which detects the mounting points for the module after the handling device has been moved into a measuring position by the control device. It is thus possible for, independent of the exact positioning of the mobile mounting device as to the receiving device between the assumed measuring position of the handling device above a mounting position and the mounting position itself, an exact travelling distance and an alignment of the mounting plane for the module to the individual mounting points to be able to be determined, so that a precise travelling movement can be activated for the module from the measuring position to the mounting position.

The measuring device arranged on the handling device, in particular on the mounting tool, has the advantage that potential errors occurring in the positioning of the mobile mounting device in the handling position as to the receiving device are eliminated, and it is possible to fit the module to the receiving device to the exact millimetre. Based on the measuring position of the handling device for detecting the mounting points, the distance and direction to the mounting points can be determined to the exact millimetre. It is preferable to use CCD cameras and/or laser scanners.

A further preferred design of the mobile mounting device provides for at least one gripper, in particular a vacuum gripper, and a mounting tool, in particular a screw, to be able to be arranged on the handling device. A rapid exchange system can be provided for this so that, for example, after the positioning and storing of the module on the receiving device, a tool exchange takes place and then the modules are fixed, in particular screwed, to the stand using the mounting tool, in particular the screw.

A preferred design of the mounting device provides for the repository to be able to be fitted exchangeably to a repository receiver on the vehicle, such as, for example, a tilting device, a swinging device or a tilting-swinging device. Thus the handling device is directly assigned to the repository so as to provide short travelling distances and therefore short mounting times. This tilting, swinging or tilting-swinging device further enables the modules allocated in transport packaging to be able to be transferred into the repository in a simple manner and then a mobile travelling device to transfer the repository into the location on the vehicle itself which is suitable for the removal of the individual modules.

A further preferred design provides for the repository receiver to be positioned on a longitudinal carriage on the loading platform, which has an exit direction far from the handling device. This enables the repository to be positioned close to the handling device, for example during the movement of the vehicle from the one handling position to the next handling position, so as to contain the total length of the vehicle neatly. Before the modules have been handled, the repository is moved away from the handling device. Thus a removal region for the modules is created, which lies within the vehicle so as to enable a simple removal of the modules from the repository.

A further preferred design of the mobile mounting device provides for at least one position detection device to be provided, with which a handling position of the handling device to the receiving device can be detected for the subsequent module mounting. It is thus possible for this mounting device, according to a first embodiment, to be able to be moved completely automatically from position detection device to position detection device, so as to then carry out the mounting cycle after this has been assumed.

Alternatively, provision can be made for the travelling movement of the mounting device from position detection device to position detection device to be counteracted by a GPS or for this to be initiated by the operator, wherein the assumption of the position is signalled and visualised for the operator.

A further preferred design of the mounting device provides for a vehicle cabin to be provided on the vehicle adjacent to the handling device and in particular opposite the repository, which can preferably be rotated in or against the direction of travel. In this vehicle cabin, a person can monitor the mounting. A manual precision control of the handling device, e.g. for programming or for final mounting, is provided by a portable remote control.

The invention and further advantageous embodiments and designs of the same are described and illustrated in greater detail below using the examples depicted in the figures. According to the invention, the features which are to be gleaned from the description and the figures can be applied individually or in any combination. The following are shown:

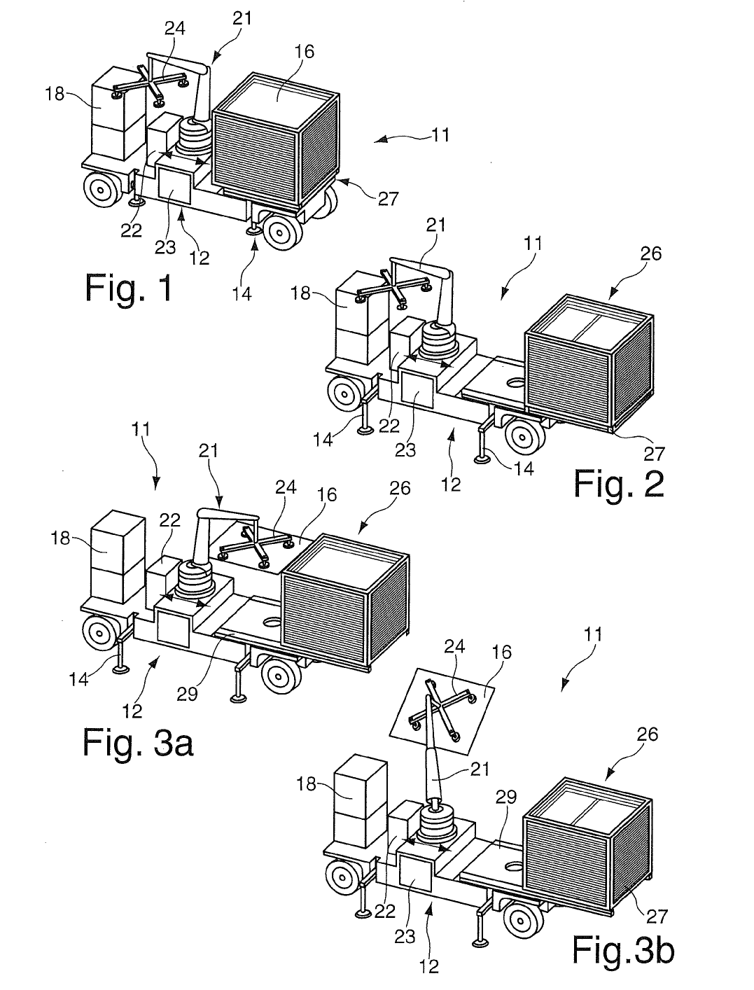

FIG. 1 shows a perspective view of a mobile mounting device,

FIG. 2 shows a schematic view of the mounting device according to FIG. 1 while a full repository is being loaded,

FIG. 3a shows a schematic view of the mobile mounting device according to FIG. 1 in a first operating position,

FIG. 3b shows a schematic view of the mounting device according to FIG. 1 in a further operating position,

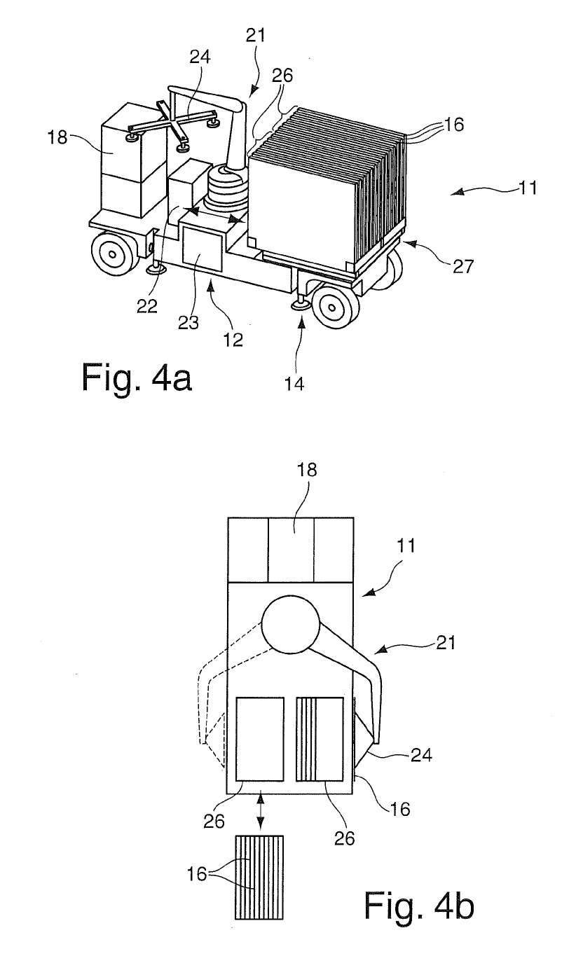

FIG. 4 shows a schematic overhead view of an alternative embodiment of the mobile mounting device according to FIG. 1 and

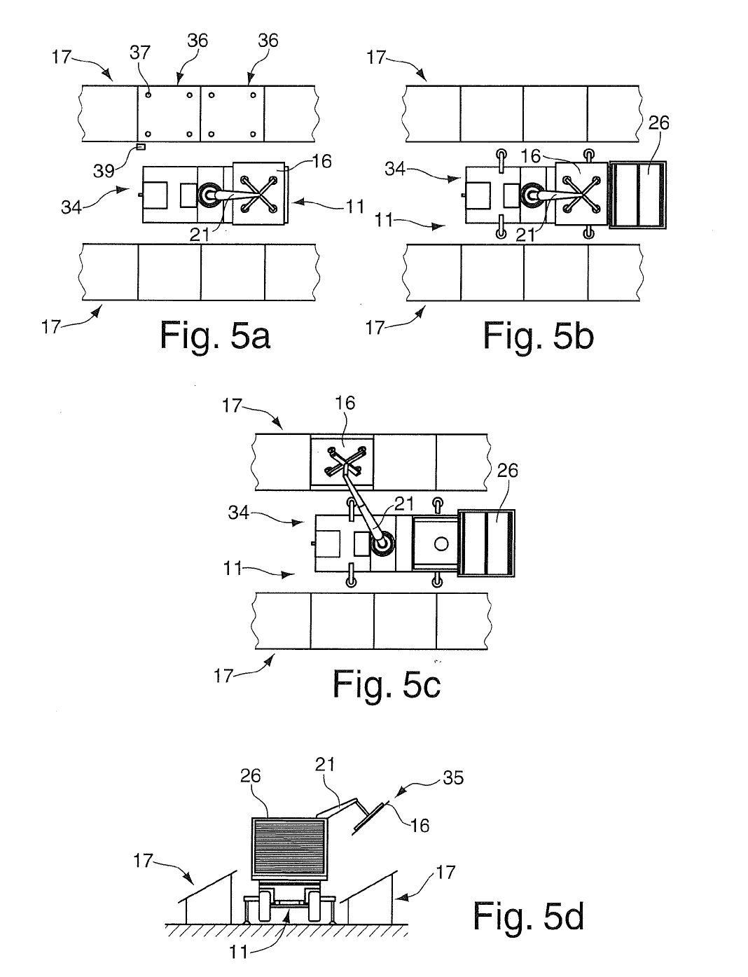

FIGS. 5a to 5d show several working steps of the mobile mounting device during module mounting.

A perspective view of a mobile mounting device 11 is depicted in FIG. 1. This mobile mounting device 11 is, for example, a self-propelled vehicle 12, which is driven by a motor which is not depicted in greater detail here. Alternatively, provision can also be made for this vehicle 12 to not be equipped with a motor and to be pulled by a tractive unit. The vehicle 12 is, for example, designed as a biaxial vehicle having one or two steering axles. A particular type of mobility of the vehicle 12 is provided in particular by the design of two steering axles. Alternatively, a chain drive can also be provided, or the vehicle 12 can be designed as a rail-mounted vehicle. In the present embodiment, the vehicle 12 has laterally arranged arms 14, which are deployed to assume a secure standing position during a mounting of a module 16 on a receiving device 17 (FIGS. 5a to 5c). The vehicle has, for example, a vehicle cabin 18 on a front end. This vehicle cabin 18 can preferably be rotated 180° or 360° so that the driver of the vehicle 12 can, on the one hand, assume a sitting position in the direction of travel and, on the other hand, assume a further sitting position, so as to monitor the handling of the modules 16. A control box 22 is provided on the vehicle 12 between a handling device 21 and the vehicle cabin 18. A space 23 for arranging hydraulic aggregates, power aggregates etc. and, where necessary, a motor, is provided underneath the handling device 21. A portable remote control is provided for precision control and programming.

The handling device 21 is designed, for example, as a single-arm robot, which is arranged rotatably around at least one spatial axis. A multiaxial handling device 21 is preferably provided, which has a gripper 24 at its front end, which is designed as a vacuum gripper. This gripper 24 is connected to the handling device 21 via an exchange system, so as to enable a fast exchange of the gripper 24 using a mounting tool which is not depicted in greater detail here, such as a power screwdriver. The handling device 21 can additionally be arranged moveably around at least one travelling axle on the vehicle 12.

A repository 26 having several modules 16 stored therein is arranged on a loading platform of the vehicle 12. The repository 26 is positioned here on the vehicle 12 in such a way that the individual modules 16 are contained in a horizontal position in the repository 26, so as to enable the individual modules 16 to be removed simply using the gripper 24.

The repository 26 is preferably equipped with several drawers with base units, said drawers being arranged parallel to one another, which are preferably fully extractable. Depending on the dimensional variations of the modules 16 which are to be mounted, one or more individual modules can be stored alongside one another in these drawers. The assembly of the repositories 26 can be carried out directly at the production site of the modules 16. Alternatively, the modules 16 can also be delivered in their previous packaging at the mounting location, and the individual modules 16 can be reloaded into the repository 26. Since the modules 16 have to date been transported upright, these are also inserted into the repository 26 upright. Then the repository 26 is transported with the modules 16 arranged upright therein to the vehicle 12 and fitted to a repository receiver 27 according to FIG. 2. This repository receiver 27 is designed as a tilting-swinging device, so that there can then be a tilting of 90° after the repository 26 has been fitted to the repository receiver 27, so that the modules 16 are aligned horizontally. Subsequently, depending on the extraction direction of the drawers, the repository 26 can additionally be turned or rotated through 90°, so as to provide an extraction direction of the drawers which points towards the handling device 21. Likewise, a tilting device can also be provided if, after the repository has been rotated 90°, the extraction direction of the drawers is then in turn facing away towards the handling device 21. Alternatively, provision can be made for it to be possible to also have a coupling around a rotational axis parallel to the longitudinal axis of the vehicle 12, instead of a coupling of the repository 26 around a transverse axis to the longitudinal axis of the vehicle on the repository receiver 27.

Furthermore, provision can alternatively be made for a repository receiver 27 to be provided to the left and right of the handling device 21, so that, during the removal of the modules 16 from a repository 26, the other can be exchanged and refilled with modules positioned on the vehicle 12, so that uninterrupted mounting can occur.

After the repository 26 has been positioned on the vehicle 12 in a transport position, as is depicted in FIG. 1, the vehicle 12 is positioned in line with the receiving device 17 for a subsequent mounting of the modules 16. The repository 26 is, as is depicted in FIG. 3, moved into a rearward removal position away from the handling device 21 using a longitudinal carriage 29, so that a removal region 31 is produced between the repository 16 and the handling device 21 for the modules 16. Then a drawer of the repository 26 can be removed, so that the gripper 24 can remove the module 16, as is depicted in FIG. 3. Then there is a travelling movement of the handling device 21 onto the receiving device 17, so as to mount the module 16. This is subsequently described in even greater detail in FIGS. 5a to 5c. After the mounting of the modules 16 in the positions provided as to the receiving device 17 has occurred, the repository 26 is returned to a transport position according to FIG. 1. The arms 14 are retracted and the vehicle 12 moves into the subsequent position for the next mounting of the modules 16. With an additional travelling axle of the handling device 21, it is possible to mount several modules 16 next to each other, if desired, without the vehicle 12 moving. Thus an increase in the working space of the handling device 21 is achieved in a standing position.

An alternative embodiment of the mobile mounting device 11 provides for one or two repositories 26 to be positioned upright, instead of the repository 26 depicted in FIGS. 1 to 3 in the same loading area of the vehicle. This alternative embodiment is depicted schematically in FIG. 4. For example, two repositories 26 are aligned in such a way that the longitudinal axes of the modules 16 point in the direction of the longitudinal axes of the vehicle. Both repositories 26 are each accessible from an external side of the vehicle, so that the handling device 21 has access to the module 16 from an external side of the vehicle, this facing at least slightly vertically upwards so as to then remove it completely from the repository 26. These repositories 26 are arranged in receiving areas provided especially for them, so that defined removal points are determined based on this positioning for the handling device 21, so as to enable an automatic mounting cycle.

The arrangement of, for example, two repositories 26, enables, after a first repository 26 has been completely emptied, this to be able to be substituted by a complete one, wherein a module removal can furthermore take place during the removal and assembly with a full repository 26 from the further repository 26, in particular if a complete exchanger repository has not yet been allocated on-site, rather only removed from an off-site store and having to be allocated to the mobile mounting device.

The present mobile mounting device 11 is used in particular for mounting individual solar modules on stands for the production of a solar park. Alternatively, this mobile mounting device 11 can also be provided for mounting glass windows, glass façades or other non-bearing façades. Furthermore, this mobile mounting device 11 can be used to clean the solar modules after such solar modules have been mounted, while, for example, instead of positioning the repository 26, filtration tanks having filtration and/or jetting liquid are positioned on the vehicle 12 and the handling device 21 contains scrapers and/or spray water nozzles so as to enable a fast and simple cleaning of the surface of the modules, whose efficiency decreases when it becomes increasingly dirty from dust clinging thereto.

In a provided dismantling of the solar power plant, it is possible for there to be a demounting in a reversed sequence without the modules 16 being damaged.

For automatic mounting of such modules 16 on receiving devices 17 using a mobile mounting device according to FIG. 1, the following procedure is provided:

The mobile mounting device 11 is positioned adjacent to a receiving device 17 or between two adjacent receiving devices 17 according to FIG. 5a. The position of the vehicle 12 as to the receiving device 17 is preferably detected by a position detection device of the mobile mounting device 11, and a travelling movement of the vehicle 12 is activated for as long as it takes before the vehicle 12 has assumed a handling position 34 for mounting one or more modules 16 on the receiving device 17. The handling position 17 determines the position of the vehicle 12 as to the receiving device 17 and the handling space of the handling device 21. The handling position 34 can be selected in such a way that one or more modules 16 can be mounted in adjacent mounting positions 36 on the receiving device 17. The handling position 34 can also be initiated manually by an operator, wherein even an inexact position can suffice.

Preceding this, the handling position 34 can be determined mathematically depending on the modular dimensions in the mounting position. The handling position 34 can lie within a mounting position 36 or even between two abutting mounting positions 36. The perpetual mounting cycle can be externally programmed once before the beginning of the mounting operations.

A mounting position 36 on the receiving device 17 represents the position wherein the module 16 rests on the receiving device 17 in alignment with the mounting points 37, so that it is subsequently possible to position fixing elements on the mounting points 37 so as to fix the module 16 onto the receiving device 17.

The mounting position 36 can be determined by three, four or more mounting points 37. Such mounting points 37 can be bore holes, grooves or indentations or suchlike, which are either applied separately or which simultaneously form a part of a fastening or connection between the module 16 and the receiving device 17. For example, a mounting point 37 can be a bore hole for a screw fitting, an indentation or groove for a sliding connection or clamping connection or a snap-on connection for a further joint connection. The module 16 is preferably fixed to the receiving device 17 by a joint connection, so that only one assembly process is required without any further effort being required for fixing by tightening screws, for example, or by securing further safety elements.

The position detection device can be designed as a navigation system. In particular, a differential GPS system is provided, whereby a potential error of inaccuracy can be excluded by the differential by applying two receivers. Further position detection systems can also be provided. As soon as the handling position 34 has been assumed, the arms 14 are deployed and the repository 26 is moved into a receiving position so as to create a receiving region 31 on the vehicle 12.

According to an alternative embodiment of the method, provision can be made for the assumption of the handling position 34 to be carried out by detecting one or more measuring marks 39, which are applied to the receiving device 17 assigned to the mounting position(s). The vehicle 12 comprises, for example, a detection sensor pointing in the direction of travel, which recognises these measuring marks 39 and also determines the distance remaining thereto, so that, with such a system, an exact handling position 34 of the vehicle 12 as to the receiving device can also be assumed.

After the vehicle 12 has assumed the handling position 34, the module 16 which is to be mounted is removed from the repository 26 using the gripper 24. This is depicted in FIG. 5b. Then the module 16 is transferred to a measuring position 35 by the handling device 21, as is depicted in FIGS. 5c and 5d. Before the module 16 is stored, the module 16 is preferably positioned in the measuring position 35 above the mounting position 36. For example, a displacement device, in particular a CCD camera, a laser scanner and/or suchlike, is provided on a rear side of the gripper 24, on the gripper 24 itself or on the handling device 21, which detects the individual mounting points 37 in the mounting position 36. Since the spatial coordinates of the handling device 21 are known from detecting the mounting points 37 and the measuring position 35, based on this, the distance that still remains between the measuring position 35 and the mounting position 37 can be detected to the exact millimetre. Alternatively, the mounting points 37 can also be detected by a measuring device arranged on the vehicle 12 or vehicle cabin 18. Then the handling device 21 and the gripper 24 can be once again rotated 180° and the module 16 can be stored and assembled exactly on the mounting point 37. A tool exchange can subsequently take place while the handling device 21, instead of the gripper 24, receives a mounting tool, in particular a power screwdriver, and while the module 16 is fixed to the receiving device 17. The handling device 21 can also be driven directly from the measuring position 35 to the mounting position 36, so that the module 16 can be subsequently positioned and fixed to the mounting points 37, in particularly fixed automatically by a joint connection. After this mounting has been carried out, an adjacent module 16 can be mounted in an adjacent mounting position 36 while retaining the same handling position 34, depending on the size of the modules 16 and/or the handling device 21.

After the modules 16 have been mounted in the handling position 34, the repository 26 is returned to a transport position corresponding to an arrangement of the repository 26 according to FIG. 1. The handling device 21 is also transferred to a transport position, as is depicted in FIG. 1, for example, and the arms 14 are refracted. Then the vehicle 12 moves into the subsequent handling position 34 and the aforementioned working steps are carried out afresh.

According to an embodiment of a mobile mounting device 11 having a repository arrangement according to FIG. 4, the individual modules 16 are removed from a repository 26 until it is empty. Then a new, repeating mounting cycle is initiated, whereby the handling device 21 removes the modules 16 from the adjacent, full repository 26 and accesses the repository 26 from the opposite external side of the vehicle.

The travelling movement of the vehicle 12 from the one handling position 34 to the subsequent handling position 34 can also take place automatically without active human intervention. This is particularly enabled by the navigation systems, which can also activate the travelling movement of the vehicle 12.

In FIG. 5d, a schematic, lateral view of the measuring position 35 of the mobile mounting device 11 in FIG. 5c is depicted. The position of the handling device 21 depicted in FIG. 5d is, for example, the measuring position 35 above the mounting position 34, wherein the module 16 points upwards in the measuring position 35, so that the measuring devices which are arranged either on the rear side of the gripper 24 or directly adjacently to the handling device 21 can detect the mounting points 37 on the receiving device 17 by scanning or by analysing image data.

Alternatively, provision can be made for the module 16 in the arrangement depicted in FIG. 5d to be positioned in the measuring position 35, i.e. the fixing points are on the free underside of the module, which form a connection with the mounting points 37. The measuring device can, for example, be provided on the gripper 24 in such a way that they are arranged outside of the dimensions of the module 16 and can still detect the mounting points 37. Thus a reduction in the travelling movement can be achieved. The mobile mounting device 11 can furthermore comprise another monitoring device, with which the handling space of the handling device 21 and the space underneath the mounting points 37 of the receiving device 17 are detected and monitored. Thus optical monitoring is created, with which people located below the receiving device 17 during the mounting of the module 16 from above onto the mounting points can be detected, if necessary.

The receiving devices 17 are mostly support structures constructed from beams, and form a stand which is fixed tightly to the ground and which has a contact surface suited to the sun, in which or adjacent to which the mounting points 37 lie for fixing the modules 16.

Furthermore, provision can alternatively be made for the transfer of the modules 16 from the removal region 31 in the vehicle to a pre-mounting position to take place automatically. The pre-mounting position is raised opposite the mounting position 36 of the modules 16 on the receiving device 17, so that a manually activated lowering of the modules is activated from the pre-mounting position to the mounting position. This represents a simplified embodiment of the mobile mounting device 11, wherein an additional measuring device is not required for detecting the measuring points.

Furthermore, provision can alternatively be made for an additional measuring system to be unnecessary on the handling device or the gripper during the detection of a handling position 34 using, for example, two measuring marks arranged on the receiving device 17, since, when assuming the handling position 34 of the vehicle 12 using both of these measuring marks, it is also known at the same time where the measuring marks 36 of the receiving device 17 are, so that a direct transfer of the modules 16 to the mounting position 36 is enabled.

1. Method for the automated mounting of modules on receiving devices, in particular solar modules on stands,
wherein a mobile mounting device comprising a handling device having a mounting tool which is appliable thereto and at least one repository having modules mounted thereon, is moved into a handling position with respect to a receiving device,
wherein a module is gripped by a mounting tool, wherein,
the handling device is transferred to a measuring position above the mounting position before the module is transferred to the mounting position,
the location of mounting points in the mounting position is determined from the measuring position and
the module is transferred to the mounting position based on the measuring position.

2. Method according to claim 1, wherein the handling device has at least one measuring device, preferably cameras which are arranged at a distance from one another, with which the mounting points of the module are detected from a measuring position and the mounting position is determined.

3. Method according to claim 1, wherein the handling position is assigned to one or more mounting positions on the receiving device when there are several mounting positions arranged in a row behind one another, and in that the handling position is determined by a position detection device of the mobile mounting device, in particular a navigation system.

4. Method according to claim 3, wherein the mobile mounting device is moved into the handling position via the position detection device.

5. Method according to claim 1, wherein a measuring mark is provided on the receiving device for module mounting of one or more modules when there are several mounting positions arranged in a row behind one another for each handling position, said measuring mark being detected by a position detection device of the mobile mounting device, and preferably in that the mobile mounting device is moved into the handling position using data from the detection device.

6. Method according to claim 1, wherein, after the module has been positioned in the mounting position, a tool exchange takes place for receiving a mounting tool using the handling device and in that the module is fixed to the receiving device using the mounting tool.

7. Method according to claim 1, wherein, the modules are mounted fully automatically to the receiving device by an assembly transfer, in particular without tools or a tool exchange.

8. Method according to claim 1, wherein, at least two repository spaces are provided on the mobile mounting device, which are each equipped with one repository, and in that the handling device removes the modules from a first repository, then removes the modules from the second repository after emptying the first repository, and for the first emptied repository to be exchanged with a full repository.

9. Method according to claim 1, wherein a mounting cycle is initiated by a control signal after positioning the mobile mounting device in a handling position to the receiving device and in that the individual working steps from the removal of the module from the repository to the mounting of the module on the receiving device and a return from the handling position to a starting position or a removal position for a further module are controlled and monitored by a computer.

10. Mobile mounting device for the mounting of modules on receiving devices, consisting of a vehicle having at least one repository which are arrangeable thereon, in which several modules are stored, having at least one uniaxial handling device having a mounting tool arranged on the vehicle which is appliable thereto, with which the modules is removed individually from the repository, and having a control device with which the handling device is activated, wherein a measuring device is provided on the handling device, which detects the mounting position for the module after the handling device has moved through the control device into a measuring position outside of the vehicle.

11. Mounting device according to claim 10, wherein the handling device contains exchangeably at least one gripper, in particularly a vacuum gripper, and at least one mounting tool, in particular a power screwdriver.

12. Mounting device according to claim 10, wherein at least one positional detection device is provided, with which a handling position of the handing device to the receiving device is detected.

13. Mounting device according to claim 10, wherein the repository is fitted exchangeably to a repository receiver, in particular a tilting device, a swinging device or a tilting-swinging device, which is fixed to the vehicle.

14. Mounting device according to claim 13, wherein the repository receiver is positioned on a longitudinal carriage on the vehicle, which has an exit direction which is far from the handling device, in particular far from the longitudinal axis of the vehicle.

15. Mounting device according to claim 10, wherein a vehicle cabin is provided adjacent to the handling device, and in particular opposite the repository, which preferably is rotateable at least 180°.
